(19) United States
(12) Patent Application Publication
(10) Pub. No.: US 2016/0162559 A1
(43) Pub. Date: Jun. 9, 2016

(54) SYSTEM AND METHOD FOR PROVIDING INSTANT QUERY

(71) Applicant: ETU CORPORATION, Taipei City (TW)

(72) Inventors: YAO-TSUNG WANG, TAIPEI CITY (TW); CHIEH-JUNG HUANG, TAIPEI CITY (TW)

(21) Appl. No.: 14/949,804

(22) Filed: Nov. 23, 2015

(30) Foreign Application Priority Data
Dec. 4, 2014 (TW) 103142111

(51) Int. Cl. G06F 17/30

(52) U.S. Cl. CPC G06F 17/30575; G06F 17/30516

(57) ABSTRACT

An information technology system provided for an instant query includes a dispatcher, a data processor and a storage system. The dispatcher receives data streams from multiple machines and transmits the data streams to a network storage device. In addition, the dispatcher creates a copy of the data streams and transmits the copy to the data processor. The data processor processes the copy according to a predetermined rule to generate an output. The output transmitted to and stored in the storage system is provided for an application to perform the instant query via an interface of the information technology system.

### CROSS-REFERENCE TO RELATED APPLICATIONS

This non-provisional application claims priority under 35 U.S.C. §119(a) on Patent Application No(s) 103142111 filed in Taiwan, R.O.C. on Dec. 4, 2014, the entire contents of which are hereby incorporated by reference.

### TECHNICAL FIELD

The technical field of the invention relates to big data, and more particularly to a system and method for providing an instant query.

### BACKGROUND

The advancement in electronic technologies leads to the explosive growth of data, which deteriorates the situation when users perform instant queries of the data for a wide range of applications. Conventional information technology (IT) systems are usually unable to provide instant query services due to the multi-tier design of system architecture or the limited access speed of a storage device such as a hard disk.

FIG. 1 is a schematic block diagram of the architecture of a conventional system. The conventional system comprises machines 1031, 1032, 1033, 1034, 1035 and 1036, which are commonly used or seen in a wide range of applications. For example, these machines can be equipment such as chemical vapor deposition machines, exposure machines or a combination thereof in the semiconductor manufacturing process. In the telco sector, these machines can be base transceiver stations installed at specific locations or computers in an operator's data center. These machines are characterized by the continuous generation of data streams, such as data continuously generated by sensors during the manufacturing process or information of geographical locations, phone numbers and IP addresses when users access services through their smart phones. In addition to the ever-growing volume of data, another challenge is the complexity that come from the mixed and diverse categories of data, including semi-structured data such as XML, log, click stream and RFID tags, unstructured data such as webpage, email, multimedia, instant message and binary file, and structured data such as OLTP and OLAP data.

As shown in FIG. 1, data streams continuously generated by the machines 1031, 1032 and 1033 are processed by or stored in a connected computer 103 while the machines 1034, 1035 and 1036 can process the data streams of their own. The data streams processed by the machines 1034, 1035 and 1036 are transmitted through a network 109 to a server for query 105 and stored in a database or storage system using hard disk as medium 107.

More and more applications, e.g. connection confirmations or alerts of factory problems, require instant queries of the data streams. Given the circumstances, if the data are stored in the database or storage system using hard disk as medium 107, the access speed will become a troublesome bottleneck. Take the semiconductor industry as an example. Any warning or alert triggered by the analysis of the data streams collected during a manufacturing process should be handled in a real-time manner. Thus, it will be more than helpful if users can perform an instant query of the data streams through a server for query 101 and quickly take a corresponding action. Most of the IT systems nowadays fail to provide such instant query of the data streams.

FIG. 2 shows an architecture of an IT system structure for processing the data streams generated by machines. The machines such as equipment 211, 213, 215 and 217 continuously generate data streams 231, 233, 235 and 237, respectively. The data streams 231, 233, 235 and 237 comprise one single category or mixed categories of structured, semi-structured or unstructured data. Subject to different applications of industries, these data can be stored for a predetermined period or updated based on a specific rule. A network storage device 25 such as a network-attached storage (NAS) or a storage area network (SAN) actively collects or passively receives the data streams 231, 233, 235 and 237 in a regular or an irregular manner. A cluster comprised of one or more servers is connected to the network storage device 25 and pre-processes the data streams 231, 233, 235 and 237 including data extraction, transformation and loading (ETL). Then, the pre-processed data are transmitted to and stored in a data warehouse 28. The data warehouse 28 can actively transmit the pre-processed data to a third-party application server 26 or a client (not shown) through an application server 29, or provide a result that fits the criteria of queries set by a user. Alternatively, the external third-party application server 26 can access the data warehouse 28 directly.

The aforementioned approach involves multiple tiers of a physical structuring mechanism for the system infrastructure, thus the data transmission between tiers is time-consuming. To be more specifically, the continuously-generated data streams 231, 233, 235 and 237 are stored in the equipment 211, 213, 215 and 217, respectively. Subsequently, the data streams 231, 233, 235 and 237 are transmitted to the network storage device 25, the cluster 27 and the data warehouse 28. The multi-tier infrastructure design disclosed herein and the use of hard disks as the storage medium lead to ineffective queries—users fail to get the latest responses to their queries of the data streams within tolerable windows, e.g. from one second to up to a few seconds.

### SUMMARY

In view of the problems stated above, a primary objective of the invention is to provide a system and method with an infrastructure design that enables an application to perform instant queries of continuously-generated data streams.

In an exemplary embodiment of this disclosure, a system for an instant query is disclosed. The system comprises a dispatcher, a data processor and a storage system. The dispatcher receives data streams from multiple machines and transmits the data streams to a network storage device which creates a backup of the data streams. On the other hand, the dispatcher creates a replica of the data streams and transmits the replica to the data processor. The data processor processes the replica according to predetermined rules and an output is generated in consequence. The output is transmitted to and stored in the storage system and is provided for an application to perform the instant query via an interface of the information technology system.

The data streams mentioned above can be logs that are continuously generated by the machines. Instead of storing the logs, the machines transmit the logs to the dispatcher through a communication protocol. The dispatcher creates two copies of the data streams, in which one copy is transmitted to the storage system and the other copy is transmitted to the data processor. The data processor comprised of at least a data refiner obtains a subset from the copy of the data streams according to a predetermined rule. The data processor processes the received copy of the data streams and the output is derived therefrom. Thereafter the output is transmitted back to the dispatcher. The dispatcher filters specific attributes of the data streams and based thereon forwards the output to a second data processor, which processes the output to generate a second output. The second output is transmitted to and stored in the storage system.

The storage system can be a non-relational database. The dispatcher and the data processor can be program modules installed in dedicated hardware components such as a master node and a worker node of a cluster, respectively.

The present invention also discloses a method for an instant query of continuously-generated data streams with properties of high volume, high variety and high velocity. With the disclosed invention, the instant queries which bring new possibilities of applications can be carried out while traditional procedures of data storage, archiving and query are set in place.

### BRIEF DESCRIPTION OF THE DRAWINGS

FIG. 1 is a schematic block diagram of a conventional query application;

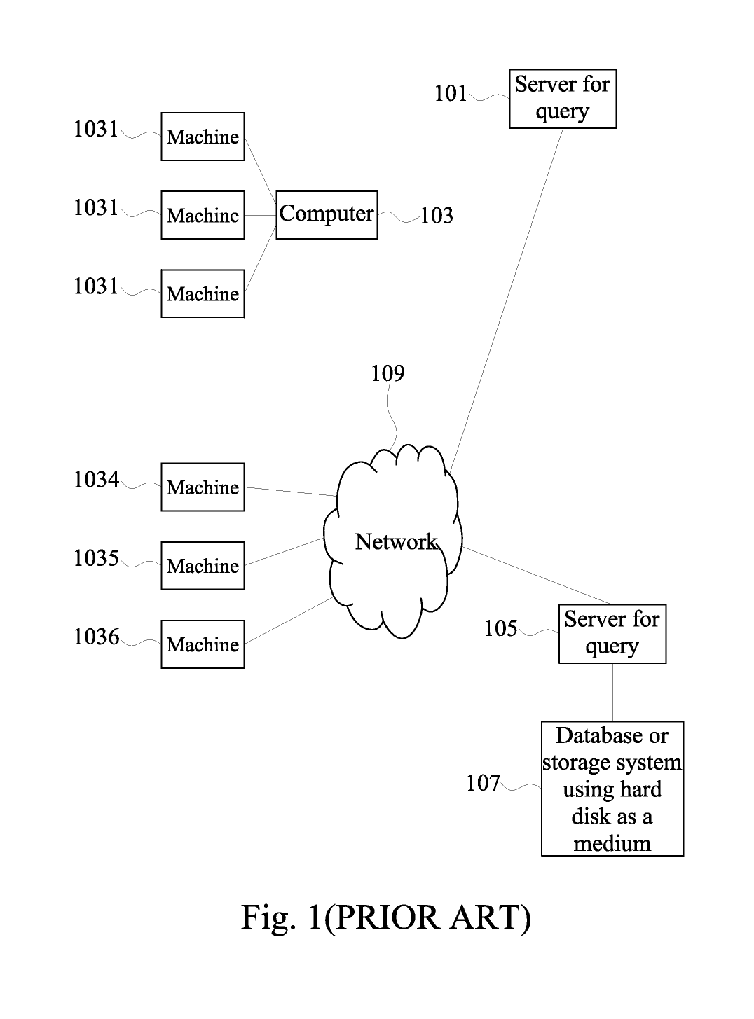

FIG. 2 is a schematic block diagram of the architecture of a conventional query system;

FIG. 3 is a schematic block diagram of the architecture of a query system in accordance with an exemplary embodiment of this disclosure;

FIG. 4 is a schematic block diagram of the architecture of a query system in accordance with another exemplary embodiment of this disclosure;

FIG. 5 is a schematic block diagram of the architecture of a query system in accordance with another exemplary embodiment of this disclosure; and

FIG. 6 is a flow chart of a method for an exemplary embodiment of this disclosure.

### DESCRIPTION OF THE PREFERRED EMBODIMENTS

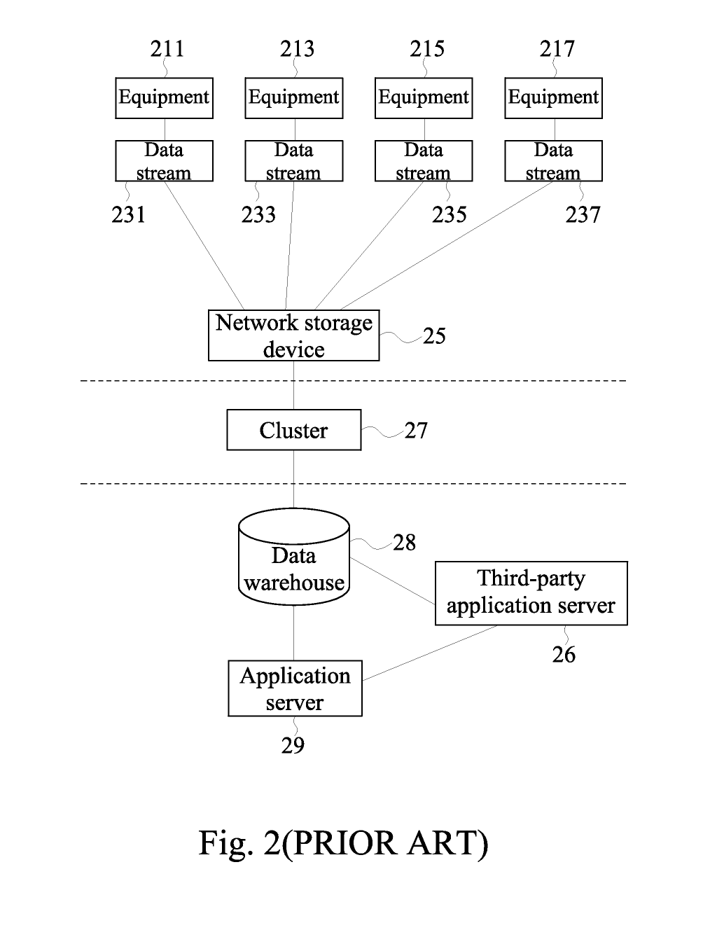

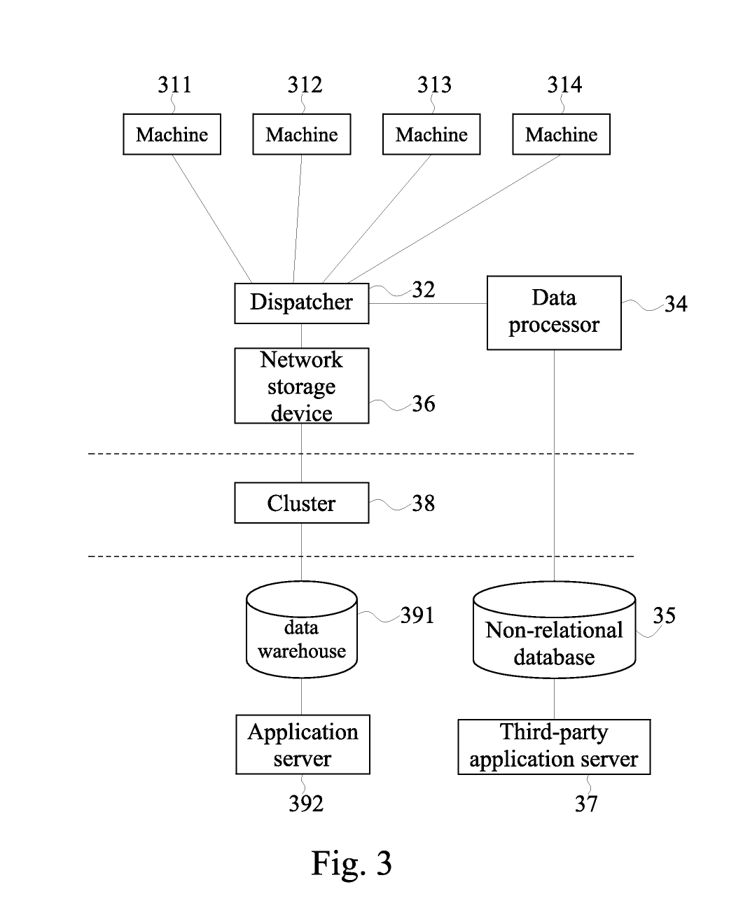

FIG. 3 is a schematic block diagram illustrating an exemplary architecture of the disclosed system that allows users to perform an instant query of the continuously-generated data streams. The data streams (not shown) generated by machines 311, 312, 313 and 314 respectively are transmitted, in the real-time manner, to a dispatcher 32 across a network (not shown) through a predetermined communication protocol. This approach saves more time compared with FIG. 2 in which the data streams 231, 233, 235 and 237 are stored in the hard disks of the equipment 211, 213, 215 and 217, respectively.

The communication protocol mentioned above can be communication protocols such as FTP, Syslog or any other protocol capable of transmitting the data streams generated by the machines 311, 312, 313 and 314 to the dispatcher 32. To facilitate the data transmission, some courses of actions can be carried out beforehand, including but not limited to settings of IP addresses, accounts and passwords for the machines 311, 312, 313 and 314, and installations of one or more software programs on the machines 311, 312, 313 and 314. The machines 311, 312, 313 and 314 can either actively and continuously transmit the data streams to the dispatcher 32, or transmit the data streams after receiving a request from the dispatcher 32.

The dispatcher 32 comprises functions of filtering and forwarding, and is executed on a master node of a cluster (not shown). In an embodiment of the present invention, the cluster comprises the master node and at least two worker nodes, wherein the dispatcher 32 is loaded into a memory of the master node and then executed. The dispatcher 32 can either allocate a buffer capacity for storing the data streams or forward the received data streams in real time. To ensure the availability and stability of the dispatcher 32, the physical structuring of the master node can be designed to provide fault tolerance, redundancy and load balance.

After receiving the aforementioned data streams, the dispatcher 32 replicates a first copy of the data streams and transmits the first copy to a network storage device 36 for data pre-processing including data extraction, transformation and loading. The first copy of the data streams being pre-processed is then transmitted to a data warehouse 391 and then accessed by an application server 392.

The dispatcher 32 can create a second copy of the data streams and transmit the second copy to a data processor 34. In an embodiment of the present invention, the data processor 34 is loaded into a memory of the worker nodes and executed.

The data processor 34 processes the second copy of the data streams based on a predetermined rule. For example, the predetermined rule may require the data processor 34 to obtain a subset of the second copy of the data streams such as 5 specific columns selected out of 20 columns. According to the predetermined rule, the data processor 34 processes the second copy of the data streams and thus acquires a processed output (not shown). More plugin functions can be added to the data processor 34 in order for fulfilling user needs.

The processed output is transmitted to a non-relational database 35 such as NoSQL. In an embodiment, the non-relational database 35 is designed to run on the aforementioned worker node such as its memory. The processed output in the non-relational database 35 is provided for a third-party application server 37 to carry out an instant query. It is worth noticing that the dispatcher 32 and the data processor 34 can handle the aforementioned data streams in real time and the processed output is directly transmitted to the non-relational database 35, none of which involves any time-consuming step such as writing the data streams to a hard disk. In addition, the architecture disclosed herein is flatter than the prior art described in FIG. 2. In use cases with massive writes, it can use the non-relational database 35 and simultaneously leverage SDRAM or NVRAM (not shown) to reduce Disk I/O. With the disclosed invention, the system enables users and/or applications to query the continuously-generated data streams and get a corresponding response within just a few seconds.

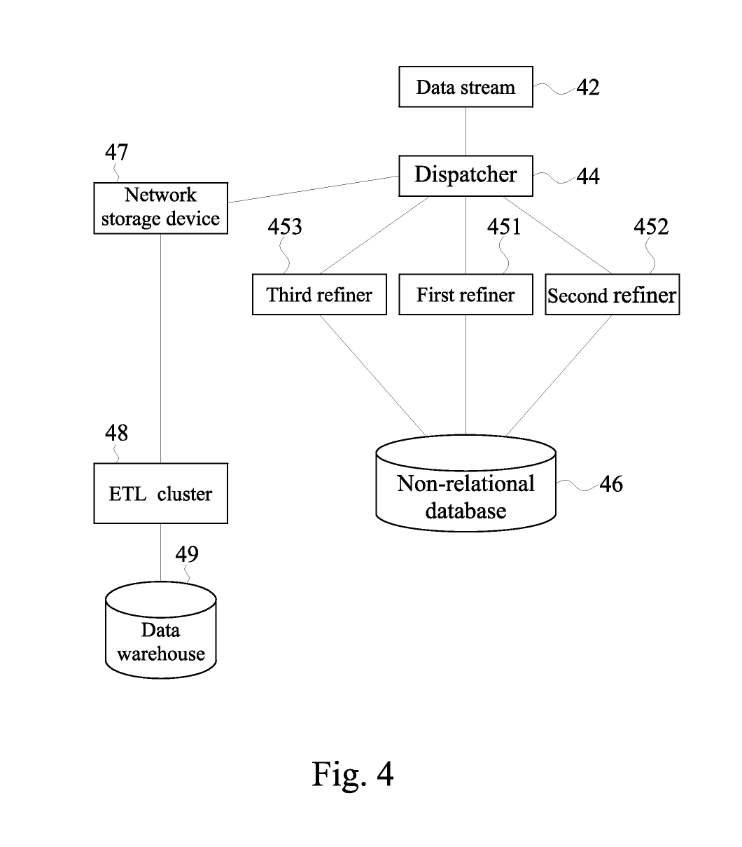

FIG. 4 is a schematic block diagram that illustrates another embodiment of the present invention. Data streams 42 are transmitted to a dispatcher 44. According to a predetermined rule, the dispatcher 44 replicates a third copy of the data streams 42 and transmits the third copy to a network storage device 47, an ETL cluster 48 and a data warehouse 49. On the other hand, the dispatcher 44 replicates a fourth copy of the data stream 42. Then, the dispatcher 44 filters a first set of specific attributes of the fourth copy and based thereon forwards a part or the whole of the fourth copy a first refiner 451, a second refiner 452 or a third refiner 453 acting as the data processors described in FIG. 3. It is well acknowledged that, in the embodiment, quantities of the dispatchers and the data processors are for example and should not limit the scope of the present invention.

In one embodiment, the first refiner 451 processes the part or the whole of the fourth copy of the data stream 42 received from the dispatcher 44 according to predetermined rules and consequently generates a first data output (not shown) which is subsequently transmitted to a non-relational database 46 such as a NoSQL. In another embodiment, the first data output is transmitted back to the dispatcher 44, which filters a second set of specific attributes of the first data output and based thereon forwards a part or the whole of the first data output to the second refiner 452 for further processing, according to the rules. After being further processed by the second refiner 452, the first data output is now turned to a second data output (not shown) and transmitted to the non-relational database 46. In still another embodiment, the second data output is transmitted back to the dispatcher 44, which filters a third set of specific attributes of the second data output and based thereon forwards a part or the whole of the second data output to the third refiner 453 for even-further processing, which turns the second data output to a third data output. The third data output is transmitted to the non-relational database 46. The processes described herein are for example and thus not meant for any limitation of the scope of the present invention. Any addition, deletion, combination, or change of the data processors or data dissemination is within the invention scope. In one embodiment the third refiner 453 executes a function different from that of the first refiner 451, while in another embodiment the third refiner 453 serves as a redundant element of the first refiner 451 so as to provide the availability.

The dispatcher 44 is executed on a master node of a cluster (not shown). In an embodiment, the cluster comprises the master node and at least two worker nodes. The dispatcher 44 is loaded into a memory of the master node and executed, while the data processors, i.e. the first refiner 451, the second refiner 452 and the third refiner 453, are loaded into memories of the worker nodes and then executed.

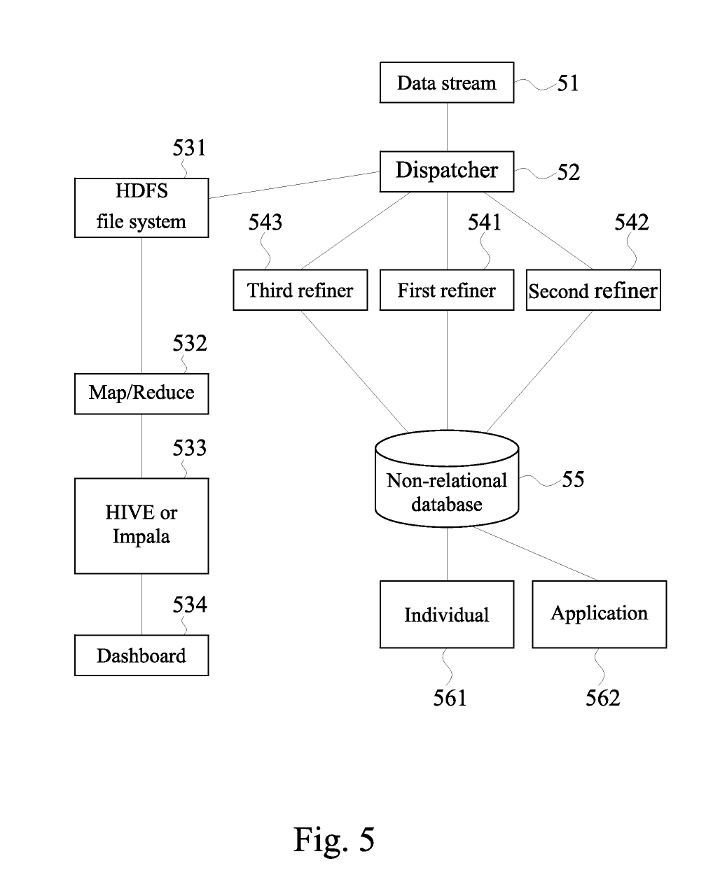

FIG. 5 is a schematic block diagram that exemplifies another embodiment of the present invention. Similar to FIG. 4, the data streams 51 are transmitted to the dispatcher 52 and then to the data processors such as the first refiner 541, the second refiner 542 and the third refiner 543 for further processing, according the rules. The data streams 51 that are further processed by the data refiners are transmitted to the non-relational database 55 and a message, e.g. a reminder or an alert, derived from a result of the data streams 51 after the further processing is sent to a user. For example, the derived message, e.g. in a form of short message service or instant messaging or the like, can be sent to an individual 561 responsible for the troubleshooting when any of machines or apparatuses in a factory goes off. Alternatively, the data streams 51 being processed can be provided for an application 562 to perform the instant query.

The system for storing and processing the data streams 51 can be replaced with a big data platform such as a platform that runs Hadoop framework, which stores and processes large data sets with a fully distributed mode. In an embodiment, the data streams are stored in a HDFS file system 531 that is highly fault-tolerant, pre-processed by MapReduce 532 and then stored in HIVE or Impala 533 acting as a data warehouse. The data streams stored in HIVE or Impala 533 are provided for queries (not shown) and/or presented in charts, in tables, on dashboards 534 or on websites, for example.

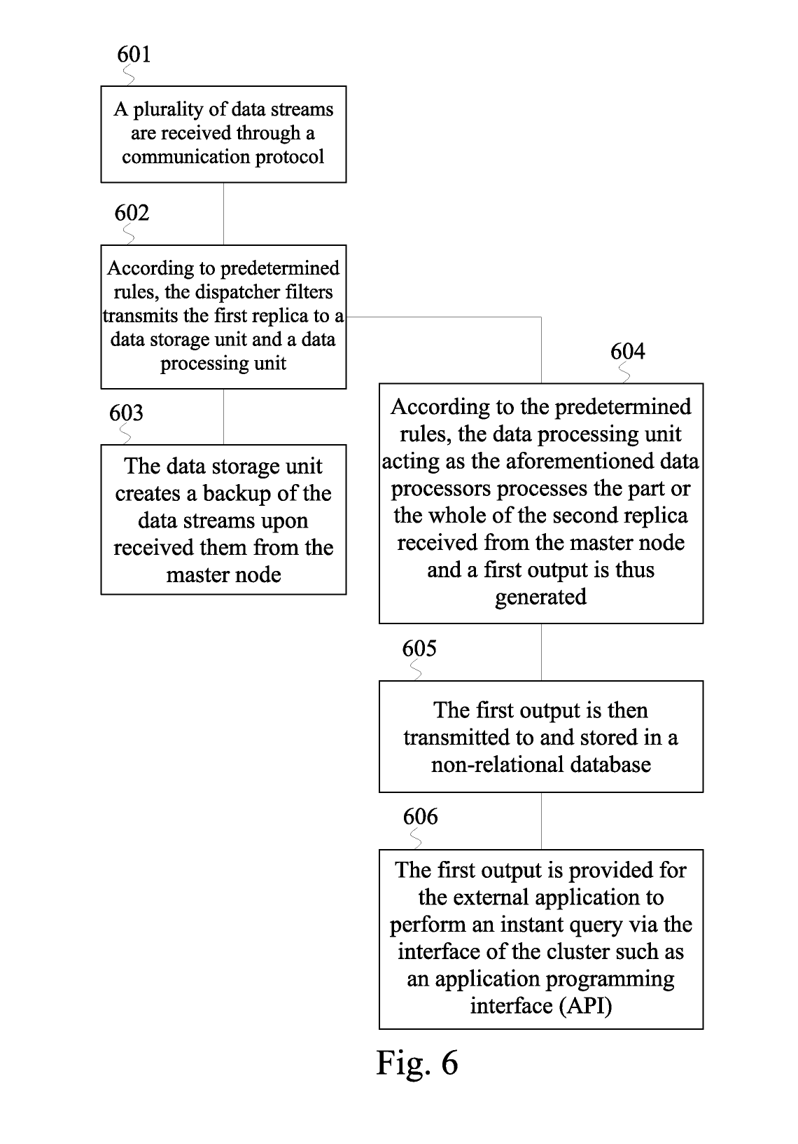

FIG. 6 is a flow chart showing a method with regard to an exemplary embodiment of this disclosure. The method is provided for instant queries of big data, particularly the aforementioned continuously-generated data streams with properties of high volume, high variety and high velocity. To be more specifically, the method is provided for an external application (not shown) to query the just-mentioned data streams via an interface (not shown) of a cluster (not shown) comprised of at least a master node and a worker node. Referring to FIG. 6, a plurality of data streams are received through a communication protocol [S601]. To disclose in detail, the data streams derived from a plurality of machines are received by the dispatcher which is executed on the master node of the cluster through the communication protocol. Thereafter, the dispatcher creates a first replica of the received data streams. According to predetermined rules, the dispatcher filters transmits the first replica to a data storage unit and a data processing unit [S602]. The dispatcher is executed in a memory of the master node and the data processing unit is within the worker node. The data storage unit creates a backup of the data streams upon received them from the master node [S603]. On the other hand, the dispatcher creates a second replica of the received data streams. The dispatcher filters a fourth set of specific attributes of the second replica and based thereon forwards a part or the whole of the second replica to the data processing unit. According to the predetermined rules, the data processing unit acting as the aforementioned data processors processes the part or the whole of the second replica received from the master node and a first output is thus generated [S604]. The first output is then transmitted to and stored in a non-relational database [S605]. The first output is provided for the external application to perform an instant query via the interface of the cluster such as an application programming interface (API) [S606].

Steps [S604] to [S606] are disclosed in detail. After receiving the second replica from the master node, the worker node processes the second replica according to the predetermined rules and generates the first output, provided for the external application to carry out the instant query. The processing of the second replica is executed in a memory of the worker node. For a purpose of further processing, the first output is transmitted back to the master node. The master node then filters a fifth set of specific attributes of the first output and based on which to forward a part or the whole of the first output to the worker node. Then, the worker node further processes the part or the whole of the first output and a second output is generated in consequence. For a purpose of even-further processing, the second output is transmitted back to the master node. Then master node filters a sixth set of specific attributes of the second output and based on which to forward a part or the whole of the second output to the worker node. The worker node carries out the even-further processing of the part or the whole of the second output; and as a consequence a third output is generated. The steps described herein are for example and not for any limitation of the present invention.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A system for providing an instant query, comprising:
a dispatcher, for receiving a plurality of continuously-generated data streams from a plurality of machines through a communication protocol, and transmitting the continuously-generated data streams to a network storage device;
a data processor, for receiving the continuously-generated data streams from the dispatcher and processing the continuously-generated data streams according to a predetermined rule to generate an output; and
a storage system, for receiving the output and providing an interface for an application to perform the instant query of the output.

2. The system as claimed in claim 1, wherein the dispatcher is executed on a master node of a cluster and comprises functions of filtering and forwarding.

3. The system as claimed in claim 2, wherein the dispatcher is executed in a memory of the master node.

4. The system as claimed in claim 1, wherein the data processor is executed on a worker node of a cluster.

5. The system as claimed in claim 4, wherein the data processor is executed in a memory of the worker node.

6. A method for providing an instant query for an application via an interface of a cluster comprised of at least a master node and a worker node, the method comprising:
receiving a plurality of continuously-generated data streams from a plurality of machines through a communication protocol and replicating a copy of the continuously-generated data streams by the master node;
filtering a first set of specific attributes of the copy and based thereon forwarding a part or the whole of the copy to the worker node by the master node; and
processing the part or the whole of the copy according to a predetermined rule to generate a first output by the worker node, wherein the first output is provided for the application to perform the instant query via the interface.

7. The method as claimed in claim 6, wherein the steps of filtering and forwarding are executed in a memory of the master node.

8. The method as claimed in claim 6, wherein the step of processing is executed in a memory of the worker node.

9. The method as claimed in claim 6, further comprising the steps of:
transmitting the first output to the master node; and
filtering a second set of specific attributes of the first output and based thereon forwarding a part or the whole of the first output to the worker node by the master node, wherein the part or the whole of the first output is processed by the worker node and a second output is generated therefrom.

10. The method as claimed in claim 9, further comprising the steps of:
transmitting the second output to the master node; and
filtering a third set of specific attributes of the second output and based thereon forwarding a part or the whole of the second output to the worker node by the master node, wherein the part or the whole of the second output is processed by the worker node and a third output is generated therefrom.
